(19) United States
(12) Patent Application Publication
(10) Pub. No.: US 2024/0211360 A1
(43) Pub. Date: Jun. 27, 2024

(54) METHOD AND SYSTEM FOR TEST SCRIPT GENERATION AND EXECUTION

(71) Applicant: HCL Technologies Limited, New Delhi (IN)

(72) Inventors: SIVA SAKTHIVEL S, Chennai (IN); SELVARAJ THANGARAJ, Chennai (IN); BANUMATHI PALANICHAMY, Chennai (IN); SRINIVASA REDDY VANUKURI, Chennai (IN); YUVARAJAN SHANMUGASUNDARAM, Chennai (IN)

(21) Appl. No.: 18/536,742

(22) Filed: Dec. 12, 2023

(30) Foreign Application Priority Data
Dec. 21, 2022 (IN) 202211074235

(51) Int. Cl. G06F 11/22

(52) U.S. Cl. CPC G06F 11/2289; G06F 11/2273

(57) ABSTRACT

The disclosure relates to method and system of test script generation and execution. The method includes capturing an execution of a test-suite on a base device-under-test (DUT), and generating configuration data based on at least one of the video of the screen associated with the base DUT during the execution of the test-suite on the base DUT and the plurality of input events associated with the execution of the test-suite on the base DUT. The method further includes generating a test script corresponding to the configuration data, and executing the test script on at least one secondary DUT.

### TECHNICAL FIELD

This disclosure relates generally to system testing, and more particularly to method and system for test script generation and execution.

### BACKGROUND

Software releases include multiple versions and milestones. The release binaries are expected to support and run in different Operating Systems and multiple versions of those Operating Systems. In particular, if the release dockers are web based, then these must run in various browsers on various types of devices under test (DUT) with various versions of Operating Systems. If there is a software release with multiple versions, then that must be tested on multiple Operating Systems, multiple versions of Operating Systems, multiple different browsers, and multiple applicable devices. DUT must run and adopt with the new implementations and bug fixes.

Running same test scenario with multiple kinds of hardware and software configurations poses multiple challenges. To achieve the execution in different DUTs, the entire test scenario/test script must be rewritten based on other OS and other hardware compatibility. As such, the test script has to be recreated so as to execute on various DUT system configurations. However, recreating the test script requires more time to recreate the test suit with the same sequence.

Therefore, there is a need for creating a single script which is compatible with multiple different DUTs running different Operating Systems, to thereby avoid delays and reduce the time taken for testing.

### SUMMARY

In an embodiment, a method of test script generation and execution is disclosed. The method may include capturing an execution of a test-suite on a first device-under-test (DUT). Capturing the execution of the test-suite on the first DUT may include recording a video of a screen associated with the first DUT during the execution of the test-suite on the first DUT and/or recording a plurality of input events associated with the execution of the test-suite on the first DUT. The method may further include creating configuration data based on at least one of the video of the screen associated with the first DUT during the execution of the test-suite on the first DUT and the plurality of input events associated with the execution of the test-suite on the first DUT. The method may further include generating a test script corresponding to the configuration data and executing the test script on a second DUT, the second DUT being unique with respect to the second DUT.

In another embodiment, a system for test script generation and execution is disclosed. The system includes a processor and a memory. The memory stores a plurality of processor-executable instructions, which upon execution, cause the processor to capture an execution of a test-suite on a first device-under-test (DUT). Capturing the execution of the test-suite on the first DUT may include recording a video of a screen associated with the first DUT during the execution of the test-suite on the first DUT and/or recording a plurality of input events associated with the execution of the test-suite on the first DUT. The plurality of processor-executable instructions, upon execution, may further cause the processor to create configuration data based on at least one of the video of the screen associated with the first DUT during the execution of the test-suite on the first DUT and the plurality of input events associated with the execution of the test-suite on the first DUT. The plurality of processor-executable instructions, upon execution, may further cause the processor to generate a test script corresponding to the configuration data, and execute the test script on a second DUT, the second DUT being unique with respect to the second DUT.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for test script generation and execution, in accordance with an embodiment of the present disclosure.

FIG. 2 illustrates a block diagram of a test script generation and execution device of FIG. 1 and showing one or more modules, in accordance with some embodiments.

FIG. 3 is a block diagram of an exemplary system for test script generation and execution, in accordance with another embodiment of the present disclosure.

FIG. 4 is a flowchart of a method of test script generation and execution, in accordance with an embodiment of the present disclosure.

FIG. 5 is a flowchart of another method of test script generation and execution, in accordance with an embodiment of the present disclosure.

FIG. 6 is an exemplary computing system that may be employed to implement processing functionality for various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims. Additional illustrative embodiments are listed below.

The present subject matter provides for methods and systems for test script generation and execution. For example, the subject matter includes two components—a component-1 associated with a recorder/test case generator and a component-2 associated with execution of the text script on different devices under test (DUT). The execution part may be done through either record and play back or through direct connection between the component-1 and the component-2. The execution on the other DUTs may be replicated like that for the base DUT. The test environment setup is similar in both the recorder and playback setup.

In some embodiments, the component-1 may record the test case from a first DUT and run it in a second DUT. The recording may be performed using tools, such as Selenium, Appium, etc. Multiple DUTs are connected in a same network, either via wired or wireless communication network. The recorded test cases with the configuration system are transmitted to all other DUTs and with the single command, to start execution of the same test cases on all other DUTs.

In particular, the component-1 may record and store the icons and events through a configuration setup. For example, the entire display may be captured as video/image files as a reference using any capturing techniques. Along with key icons their corresponding locations and number of screens with labelling are also captured and stored. As such, the screens, objects in the screens, locations of the selected objects, and corresponding events on that object are recorded with the help of recording system. Additionally, a priority numbering system may be included as well for the test execution.

For example, the component-1 includes a video capturing module for the DUT display. Further, the component-1 records keyboard and mouse events, performs object identification with image processing on the captured video/images. Based on the captured video/audio and the mouse and keyboard events, a configuration is created. Finally, a script generation module generates the test script

The component-2 performs object verification with the stored labels for each event. The object verification is irrespective of DUTs hardware and software configuration. Further, the object verification can be either pattern/icon verification or image verification. Once the object verification test case result is pass, then the event handling can take place in the execution system.

Similar test script execution takes place in the multiple connected DUTs with the recorded/parallel test script execution. The test script is executed. Based on the object detection and events sequence from the configuration data, keyboard/mouse actions are performed on the other DUTs, and a similar test report is generated. Additionally, verification may be performed by comparing and verifying the source testing video with the current execution video and configured pattern/icon identification during automation testing. After icon identification, identification of subsequent display changes is done through unique pattern verification based on the flow of displays screens.

Therefore, the present subject matter provides for simultaneous execution of the test scripts on multiple DUTs. The base DUT may be connected with a) capture card, or b) a keyboard mouse simulator/Ethernet/robotic-arm. The capture card captures the base DUT's events, and based on that, system's keyboard and mouse events from the base DUT are recorded. These events are transferred through the component-1. The events are executed on all other connected DUTs, same as on the base DUT. The component-2 reflects the same keyboard and mouse events on all the connected DUTs parallelly. The components-1 receives all the commands and events with respective objects and transfers to the component-2. The component-2 executes the same as the component-1.

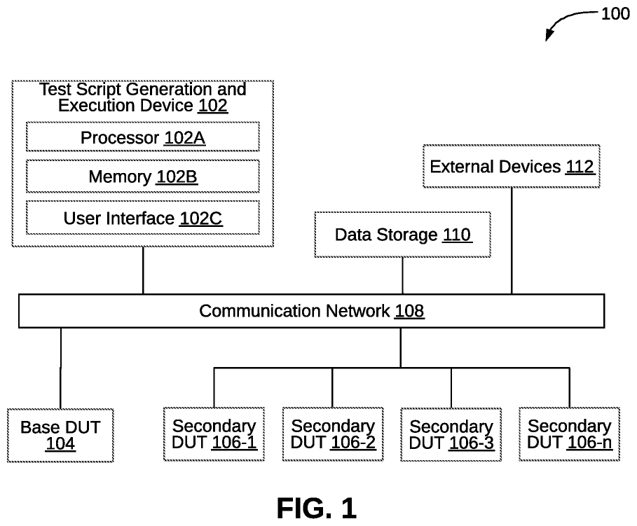

Referring now to FIG. 1, a block diagram of an exemplary system 100 for test script generation and execution is illustrated, in accordance with some embodiments of the present disclosure. The system 100 may implement a test script generation and execution device 102. The test script generation and execution device 102 may be a computing device having data processing capability. Examples of the test script generation and execution device 102 may include, but are not limited to a desktop, a laptop, a notebook, a netbook, a tablet, a smartphone, a mobile phone, an application server, a web server, or the like. Further, the system 100 may include a base device under test (DUT) 104 and one or more secondary devices under test (DUT) 106-1, 106-2, 106-3, . . . 106-n (hereinafter, collectively or individually referred to as one or more secondary DUT 106). The system 100 may further include a data storage 110. Additionally, the test script generation and execution device 102 may be communicatively coupled to an external device 112 for sending and receiving various data. Examples of the external device 112 may include, but are not limited to, a remote server, digital devices, and a computer system. A computing device, a smartphone, a mobile device, a laptop, a smartwatch, a personal digital assistant (PDA), an e-reader, and a tablet are all examples of external devices 112.

The test script generation and execution device 102 may connect to the base DUT 104, the one or more secondary DUTs 16, and to the external device 112 over a communication network 108. The test script generation and execution device 102 may connect to external device 112 via a wired connection, for example via Universal Serial Bus (USB).

The test script generation and execution device 102 may be configured to perform one or more functionalities that may include capturing an execution of a test-suite on a base device-under-test (DUT). Capturing the execution of the test-suite on the base DUT comprises recording at least one of a video of a screen associated with the base DUT during the execution of the test-suite on the base DUT and a plurality of input events associated with the execution of the test-suite on the base DUT. The one or more functionalities may further include creating configuration data based on at least one of the video of the screen associated with the base DUT during the execution of the test-suite on the base DUT and the plurality of input events associated with the execution of the test-suite on the base DUT. The one or more functionalities may further include generating a test script corresponding to the configuration data and executing the test script on a secondary DUT, the secondary DUT being unique with respect to the base DUT.

To perform the above functionalities, the test script generation and execution device 102 may include a processor 102A and a memory 102B. The memory 102B may be communicatively coupled to the processor 102A. the memory 102B may store a plurality of instructions, which upon execution by the processor 102A, cause the processor to perform the above functionalities. The test script generation and execution device 102 may further implement a user interface 102C, 102C that may further implement a display. Examples may include, but are not limited to a display, keypad, microphone, audio speakers, vibrating motor, LED lights, etc. The user interface 102C may receive input from a user and also display an output of the computation performed by the test script generation and execution device 102.

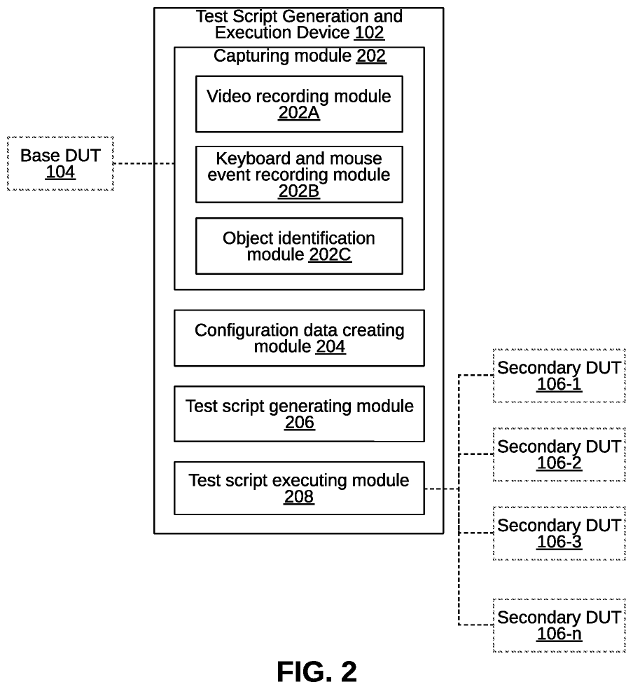

Referring now to FIG. 2, a block diagram of the test script generation and execution device 102 showing one or more modules is illustrated, in accordance with some embodiments. In some embodiments, the test script generation and execution device 102 may include a capturing module 202, a configuration data creating module 204, a test script generating module 206, and a test script executing module 208. In some embodiments, the capturing module 202 may further implement a video recording module 202A, a keyboard and mouse event recording module 202B, and an object identification module 202C.

The capturing module 202 may capture an execution of a test-suite on the base DUT 104. Capturing the execution of the test-suite on the base DUT 104 may include comprises recording a video of a screen associated with the base DUT 104 during the execution of the test-suite on the base DUT 104 and/or recording a plurality of input events associated with the execution of the test-suite on the base DUT 104. In some embodiments, a sequence of the plurality of input events associated with the execution of the test-suite on the base DUT 104 may be recorded as well. To this end, the video recording module 202A may be configured to record the video of a screen associated with the base DUT 104 during the execution of the test-suite on the base DUT 104. The keyboard and mouse event recording module 202B may be configured to record at least one keyboard input event and at least one mouse input event that takes place during the execution of the test-suite on the base DUT 104. The object identification module 202C may be configured to identify one or more objects within the video of the screen associated with the base DUT 104 during the execution of the test-suite on the base DUT. The one or more objects may be identified using any image processing technique, or an optical character recognition (OCR) technique, or a machine leaning (ML) model. The object identification module 202C may be further configured to identify and record a location of each of the one or more objects with respect to the display screen.

The configuration data creating module 204 may generate configuration data based on at least one of the video of the screen associated with the base DUT 104 during the execution of the test-suite on the base DUT 104 and the plurality of input events associated with the execution of the test-suite on the base DUT 104. The test script generating module 206 may generate a test script corresponding to the configuration data. The test script executing module 208 may execute the test script on one or more secondary DUT 106. It should be noted that executing the test script on the secondary DUTs 106 may include executing a keyboard action on the secondary DUT 106 corresponding to the keyboard input associated with the base DUT 104, in association with the one or more objects. Executing the test script on the secondary DUT 106 may further include executing a mouse action on the secondary DUT 106 corresponding to the mouse input associated with the base DUT 104, in association with the one or more objects.

In some example embodiments, the keyboard action may be executed via a keyboard simulator. In other example embodiments, the keyboard action may be executed via a robotic arm configured to press one or more keys of the keyboard associated with the secondary DUT 106. Similarly, the mouse action may be executed via a mouse simulator, or alternately, via a robotic arm configured to perform a mouse action associated with the secondary DUT 106.

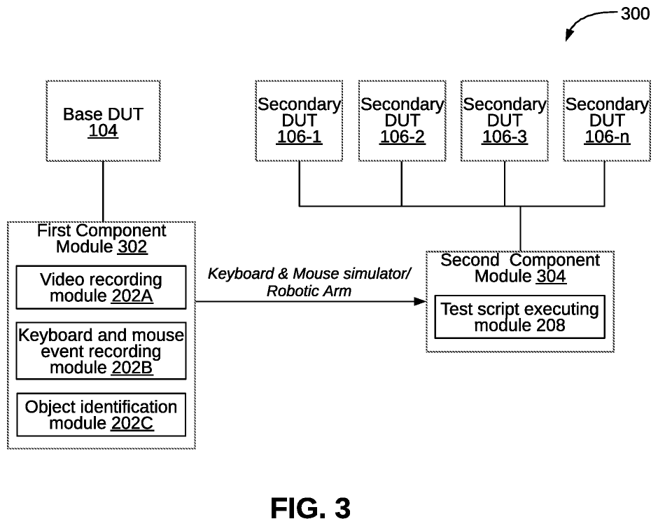

Referring now to FIG. 3, a block diagram of an exemplary system 300 (corresponding to the exemplary system 100) for test script generation and execution is illustrated, in accordance with some embodiments of the present disclosure. The system 100 may implement the test script generation and execution device 102.

By way of an example, as shown in FIG. 3, the test script generation and execution device 102 may implement two component modules—a first component module 302 associated with a recorder or test case generator and a second component module 304 associated with execution of the text script on different secondary DUTs 106. The execution on the secondary DUTs 106 may be replicated like that for the base DUT 104.

For example, am example test case executed on the base DUT 104 may include following steps: (1) Open “YouTube” application, (2) open a newly launch video, and (3) verify the loading/playback performance of the video. This sample test case may be required to be verified on different secondary DUTs 106. For example, the secondary DUTs 106 may have an operating system from the base DUT 104. Further, the secondary DUTs 106 could be any one of the following devices or the testing might include all the below devices which can run parallelly: a Television, a media player, a gaming console, a MAC/Linux/Windows PC, etc. As such, the same kind of test scenario may be implemented on the different secondary DUTs 106. Some example test scenarios may correspond to in-flight entertainment (IFE), in-vehicle infotainment (IVI), line replaceable units (LRU), blood glucose metering, sterilizers, infusion pumps, with/without display, etc.

In some embodiments, the first component module 302 may record the test case from the base DUT 104 and run it one the secondary DUT(s) 106. The recording may be performed using tools, such as Selenium, Appium, etc. further, multiple DUTs may be connected in a same network, either via wired or wireless communication network. The recorded test cases with the configuration system may be transmitted to all the secondary DUTs 106, and with a single command, the execution of the same test cases on all the secondary DUTs 106 may be started.

In particular, the first component module 302 may record and store the icons and events through a configuration setup. For example, the entire display may be captured as video/image files as a reference using any capturing techniques, using the video recording module 202A. Further, key icons their corresponding locations and number of screens with labelling may be captured and stored, using the object identification module 202C. Furthermore, events on that object may be recorded using the keyboard and mouse event recording module 202B. A priority numbering system may be included as well for the test execution. Based on the captured video/audio and the mouse and keyboard events, configuration data may be generated. Finally, a script may be generated using the configuration data.

The second component module 304 may perform object verification with the stored labels for each event. The object verification may be non-dependent on the secondary DUT's hardware and software configuration. Further, the object verification may be based on either pattern/icon verification or image verification. Once the object verification test case result is pass, then the event handling can take place in the execution system.

The second component module 304 may perform test script execution in the multiple secondary DUT 106 using the recorded/parallel test script execution. Based on the object detection and events sequence from the configuration data, keyboard/mouse actions may be performed on the multiple secondary DUT 106, and a test report may be generated.

The execution may be performed by executing keyboard action via a keyboard simulator or a robotic arm configured to press one or more keys of the keyboard associated with the secondary DUT 106. Similarly, the mouse action may be executed via a mouse simulator or a robotic arm configured to perform a mouse action associated with the secondary DUT 106.

Additionally, verification may be performed by comparing and verifying the source testing video with the current execution video and configured pattern/icon identification during automation testing. After icon identification, identification of subsequent display changes is done through unique pattern verification based on the flow of displays screens.

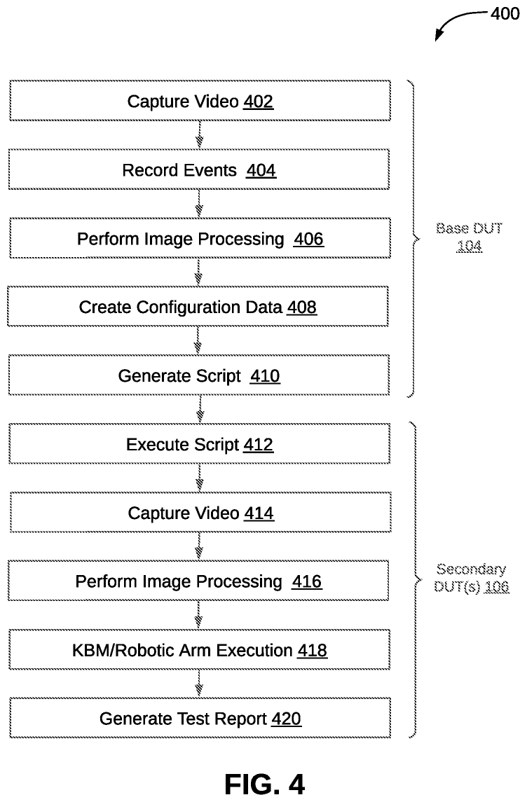

Referring now to FIG. 4, a flowchart of a method 400 of test script generation and execution is illustrated, in accordance with some embodiments of the present disclosure. The method 400 may be performed by the test script generation and execution 102, as described above.

Steps 402-410 are performed with respect to the base DUT 104. At step 402, a video may be captured corresponding to an execution of a test-suite on the base DUT 104. For example, when the test-suite is executed on the base DUT 104, the various different display screens of the base DUT 104 are captured. In other words, a video comprised of screenshots of the display screens of the base DUT 104 at different stages of the test execution are captured. At step 404, one or more input events occurring during the execution of the test-script are recorded. For example, the input events associated with the execution of the test-suite on the base DUT 104 may include at least one keyboard input and at least one mouse input. Further, a sequence of the input events associated with the execution of the test-suite on the base DUT 104 may also recorded. In some embodiments, steps 402, 404 may be performed simultaneously.

At step 406, image processing may be performed on the images (i.e. frames) associated with the video captured at step 402. Based on the image processing, one or more objects may be identified within the video of the screen associated with the base DUT 104 during the execution of the test-suite on the base DUT 104. At step 408, configuration data is generated based on at least one of the video of the screen associated with the base DUT 104 during the execution of the test-suite on the base DUT 104 and the input events associated with the execution of the test-suite on the base DUT 104. At step 410, a test script is generated corresponding to the configuration data which is generated at step 408.

Once the test script is generated, then at step 412, the test script is executed on the one or more secondary DUT(s) 106. It should be noted that the one or more secondary DUT(s) 106 may differ from the base DUT 104 in terms of operation system, device type, etc. For example, the base DUT 104 may have a “Microsoft Windows” based operating system, whereas each of the one or more secondary DUT(s) 106 may have an “Android” based, or “Apple IOS” based, or “Linux” based device operating system. In other examples, the base DUT 104 may be a smartphone, whereas each of the one or more secondary DUT(s) 106 may be either a Television, a gaming console, a media player, a desktop, etc.

At step 414, during the execution of the test-script on the secondary DUT(s) 106, a video may be captured corresponding to the execution of the test-suite on the respective secondary DUT(s) 106. As such, when the test-suite is executed on the secondary DUT 106, the various different display screens of the secondary DUT 106 are captured. At step 416, image processing may be performed on the images (i.e. frames) associated with the video captured at step 412. Based on the image processing, one or more objects may be identified within the video of the screen associated with the secondary DUT 106 during the execution of the test-suite on the secondary DUT 106.

At step 418, input events associated with the execution of the test-suite on the secondary DUT 106 are determined. For example, the input events include keyboard inputs and mouse inputs. Further, at step 418, a keyboard action is executed on the secondary DUT corresponding to the keyboard input associated with the base DUT, in association with the one or more objects identified at step 416. Similarly, a mouse action is executed on the secondary DUT corresponding to the mouse input associated with the base DUT, in association with the one or more objects. By way of an example, the keyboard action or the mouse action may be executed using a keyboard and mouse simulator or a robotic arm which may perform the actions on the keyboard and mouse associated with the secondary DUTs 106. At step 420, a test report may be generated, based on the execution of the test-script on each of the one or more secondary DUTs 106.

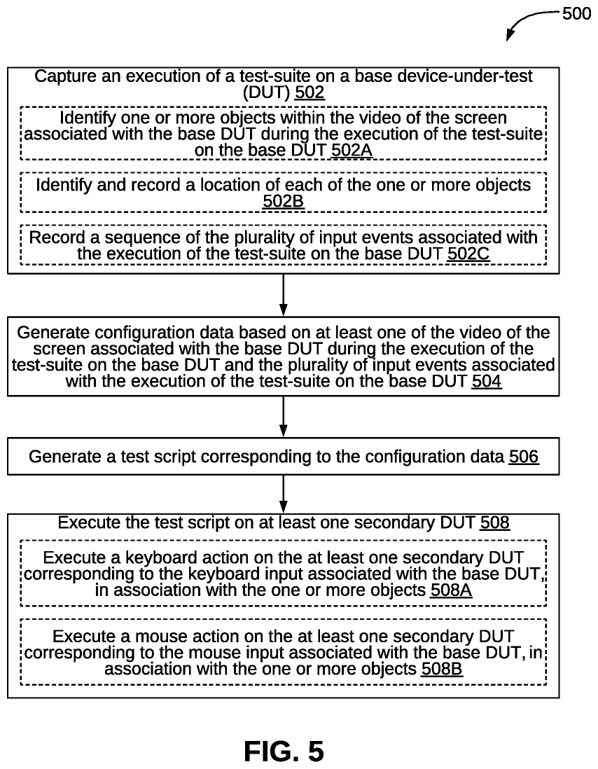

Referring now to FIG. 5, a flowchart of a method 500 of test script generation and execution is illustrated, in accordance with some embodiments of the present disclosure. The method 500 may be performed by the test script generation and execution 102, as described above.

At step 502, an execution of a test-suite on the base device-under-test (DUT) 104 may be captured. Capturing the execution of the test-suite on the base DUT may include recording a video of a screen associated with the base DUT 104 during the execution of the test-suite on the base DUT and 104/or recording a plurality of input events associated with the execution of the test-suite on the base DUT 104. In some embodiments, in order to capture the execution of the test-suite on the base DUT, additional steps 502A-502C may be performed. At step 502A, one or more objects within the video of the screen associated with the base DUT during the execution of the test-suite on the base DUT 104 may be identified. The one or more objects may be identified using one or more image processing techniques, optical character recognition (OCR) techniques, machine leaning (ML) models, etc. At step 502B, a location of each of the one or more objects may be identified and recorded. At step 502C, a sequence of the plurality of input events associated with the execution of the test-suite on the base DUT 104 may be recorded. It should be noted that the plurality of input events associated with the execution of the test-suite on the base DUT 104 may include at least one keyboard input (e.g. pressing of one or more keys of the keyboard) and at least one mouse input (e.g. scrolling of the cursor, selecting an object, or clicking on an object using the mouse).

At step 504, configuration data may be generated based on at least one of the video of the screen associated with the base DUT 104 during the execution of the test-suite on the base DUT 104 and the plurality of input events associated with the execution of the test-suite on the base DUT 104. At step 506, a test script may be generated corresponding to the configuration data.

At step 508, the test script may be generated on each of the at least one secondary DUT 106. In some embodiments, executing the test script on the secondary DUT 106 may include executing a keyboard action on the at least one secondary DUT 106 corresponding to the keyboard input associated with the base DUT 104, in association with the one or more objects, or executing a mouse action on the at least one secondary DUT 106 corresponding to the mouse input associated with the base DUT 104, in association with the one or more objects. For example, the keyboard action may be executed via either a keyboard simulator or a robotic arm configured to press one or more keys of the keyboard associated with the at least one secondary DUT 106. Similarly, the mouse action may be executed via either a mouse simulator or a robotic arm configured to perform a mouse action associated with the at least one secondary DUT 106.

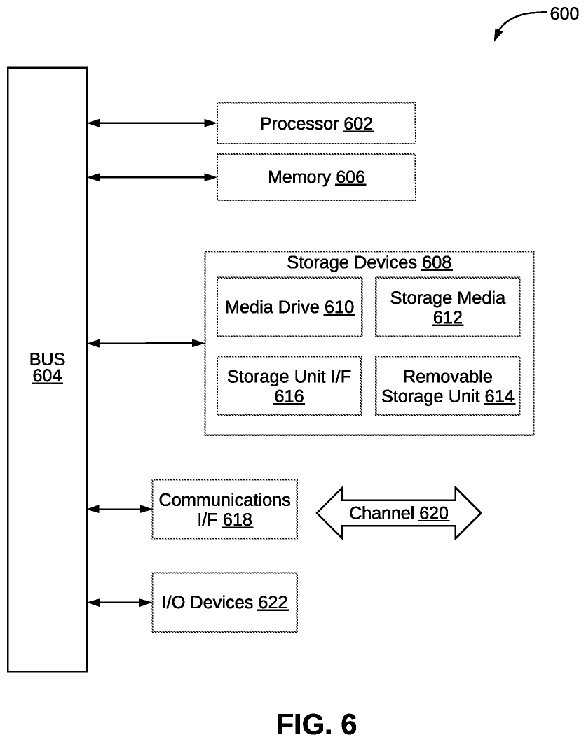

Referring now to FIG. 6, an exemplary computing system 600 that may be employed to implement processing functionality for various embodiments (e.g., as a SIMD device, client device, server device, one or more processors, or the like) is illustrated. Those skilled in the relevant art will also recognize how to implement the invention using other computer systems or architectures. The computing system 600 may represent, for example, a user device such as a desktop, a laptop, a mobile phone, personal entertainment device, DVR, and so on, or any other type of special or general-purpose computing device as may be desirable or appropriate for a given application or environment. The computing system 600 may include one or more processors, such as a processor 602 that may be implemented using a general or special purpose processing engine such as, for example, a microprocessor, microcontroller or other control logic. In this example, the processor 602 is connected to a bus 604 or other communication media. In some embodiments, the processor 602 may be an Artificial Intelligence (AI) processor, which may be implemented as a Tensor Processing Unit (TPU), or a graphical processor unit, or a custom programmable solution Field-Programmable Gate Array (FPGA).

The computing system 600 may also include a memory 606 (main memory), for example, Random Access Memory (RAM) or other dynamic memory, for storing information and instructions to be executed by the processor 602. The memory 606 also may be used for storing temporary variables or other intermediate information during the execution of instructions to be executed by processor 602. The computing system 600 may likewise include a read-only memory (“ROM”) or other static storage device coupled to bus 604 for storing static information and instructions for the processor 602.

The computing system 600 may also include storage devices 608, which may include, for example, a media drive 610 and a removable storage interface. The media drive 610 may include a drive or other mechanism to support fixed or removable storage media, such as a hard disk drive, a floppy disk drive, a magnetic tape drive, an SD card port, a USB port, a micro-USB, an optical disk drive, a CD or DVD drive (R or RW), or other removable or fixed media drive. A storage media 612 may include, for example, a hard disk, magnetic tape, flash drive, or other fixed or removable media that is read by and written to by the media drive 610. As these examples illustrate, the storage media 612 may include a computer-readable storage medium having stored therein particular computer software or data.

In alternative embodiments, the storage devices 608 may include other similar instrumentalities for allowing computer programs or other instructions or data to be loaded into the computing system 600. Such instrumentalities may include, for example, a removable storage unit 614 and a storage unit interface 616, such as a program cartridge and cartridge interface, a removable memory (for example, a flash memory or other removable memory module) and memory slot, and other removable storage units and interfaces that allow software and data to be transferred from the removable storage unit 614 to the computing system 600.

The computing system 600 may also include a communications interface 618. The communications interface 618 may be used to allow software and data to be transferred between the computing system 600 and external devices. Examples of the communications interface 618 may include a network interface (such as an Ethernet or other NIC card), a communications port (such as for example, a USB port, a micro-USB port), Near field Communication (NFC), etc. Software and data transferred via the communications interface 618 are in the form of signals which may be electronic, electromagnetic, optical, or other signals capable of being received by the communications interface 618. These signals are provided to the communications interface 618 via a channel 620. The channel 620 may carry signals and may be implemented using a wireless medium, wire or cable, fiber optics, or other communications medium. Some examples of the channel 620 may include a phone line, a cellular phone link, an RF link, a Bluetooth link, a network interface, a local or wide area network, and other communications channels.

The computing system 600 may further include Input/Output (I/O) devices 622. Examples may include, but are not limited to a display, keypad, microphone, audio speakers, vibrating motor, LED lights, etc. The I/O devices 622 may receive input from a user and also display an output of the computation performed by the processor 602. In this document, the terms “computer program product” and “computer-readable medium” may be used generally to refer to media such as, for example, the memory 606, the storage devices 608, the removable storage unit 614, or signal(s) on the channel 620. These and other forms of computer-readable media may be involved in providing one or more sequences of one or more instructions to the processor 602 for execution. Such instructions, generally referred to as “computer program code” (which may be grouped in the form of computer programs or other groupings), when executed, enable the computing system 600 to perform features or functions of embodiments of the present invention.

In an embodiment where the elements are implemented using software, the software may be stored in a computer-readable medium and loaded into the computing system 600 using, for example, the removable storage unit 614, the media drive 610 or the communications interface 618. The control logic (in this example, software instructions or computer program code), when executed by the processor 602, causes the processor 602 to perform the functions of the invention as described herein.

It is intended that the disclosure and examples be considered as exemplary only, with a true scope and spirit of disclosed embodiments being indicated by the following claims.

What is claimed is:

1. A method of test script generation and execution, the method comprising:
capturing, by a test script generation and execution device, an execution of a test-suite on a base device-under-test (DUT), wherein capturing the execution of the test-suite on the base DUT comprises recording at least one of:
a video of a screen associated with the base DUT during the execution of the test-suite on the base DUT; and
a plurality of input events associated with the execution of the test-suite on the base DUT;
generating, by the test script generation and execution device, configuration data based on at least one of the video of the screen associated with the base DUT during the execution of the test-suite on the base DUT and the plurality of input events associated with the execution of the test-suite on the base DUT;
generating, by the test script generation and execution device, a test script corresponding to the configuration data; and
executing, by the test script generation and execution device, the test script on at least one secondary DUT.

2. The method of claim 1, wherein capturing the execution of the test-suite on the base DUT further comprises:
identifying one or more objects within the video of the screen associated with the base DUT during the execution of the test-suite on the base DUT, wherein the one or more objects are identified based on at least one of: image processing, optical character recognition (OCR), and machine learning (ML).

3. The method of claim 2, wherein capturing the execution of the test-suite on the base DUT further comprises:
identifying and recording a location of each of the one or more objects.

4. The method of claim 1, wherein capturing the execution of the test-suite on the base DUT further comprises:
recording a sequence of the plurality of input events associated with the execution of the test-suite on the base DUT.

5. The method of claim 1, wherein the plurality of input events associated with the execution of the test-suite on the base DUT comprises:
at least one keyboard input; and
at least one mouse input.

6. The method of claim 5, wherein executing the test script on the at least one secondary DUT comprises at least one of:
executing a keyboard action on the at least one secondary DUT corresponding to the keyboard input associated with the base DUT, in association with the one or more objects; and
executing a mouse action on the at least one secondary DUT corresponding to the mouse input associated with the base DUT, in association with the one or more objects.

7. The method of claim 6, wherein the keyboard action is executed via one of:
a keyboard simulator; and
a robotic arm configured to press one or more keys of the keyboard associated with the at least one secondary DUT.

8. The method of claim 6, wherein the mouse action is executed via one of:
a mouse simulator; and
a robotic arm configured to perform a mouse action associated with the at least one secondary DUT.

9. A system for test script generation and execution, the system comprising:
a processor; and
a memory communicatively coupled to the processor, wherein the memory stores a plurality of instructions, which upon execution by the processor, cause the processor to:
capture an execution of a test-suite on a base device-under-test (DUT), wherein capturing the execution of the test-suite on the base DUT comprises recording at least one of:
a video of a screen associated with the base DUT during the execution of the test-suite on the base DUT; and
a plurality of input events associated with the execution of the test-suite on the base DUT;
generate configuration data based on at least one of the video of the screen associated with the base DUT during the execution of the test-suite on the base DUT and the plurality of input events associated with the execution of the test-suite on the base DUT;
generate a test script corresponding to the configuration data; and
execute the test script on a at least one secondary DUT.

10. The system of claim 9, wherein capturing the execution of the test-suite on the base DUT further comprises:
identifying one or more objects within the video of the screen associated with the base DUT during the execution of the test-suite on the base DUT, wherein the one or more objects are identified based on at least one of: image processing, optical character recognition (OCR), and machine learning (ML), and
recording a sequence of the plurality of input events associated with the execution of the test-suite on the base DUT.

11. The system of claim 10, wherein the plurality of input events associated with the execution of the test-suite on the base DUT comprises:
at least one keyboard input; and
at least one mouse input.

12. The system of claim 11,
wherein executing the test script on the at least one secondary DUT comprises at least one of:
executing a keyboard action on the at least one secondary DUT corresponding to the keyboard input associated with the base DUT, in association with the one or more objects; and
executing a mouse action on the at least one secondary DUT corresponding to the mouse input associated with the base DUT, in association with the one or more objects,
wherein the keyboard action is executed via one of:
a keyboard simulator; and
a robotic arm configured to press one or more keys of the keyboard associated with the at least one secondary DUT, and
wherein the mouse action is executed via one of:
a mouse simulator; and
a robotic arm configured to perform a mouse action associated with the at least one secondary DUT.

13. A non-transitory computer-readable medium storing computer-executable instructions for test script generation and execution, the computer-executable instructions configured for:
capturing an execution of a test-suite on a base device-under-test (DUT), wherein capturing the execution of the test-suite on the base DUT comprises recording at least one of:
a video of a screen associated with the base DUT during the execution of the test-suite on the base DUT; and
a plurality of input events associated with the execution of the test-suite on the base DUT;
generating configuration data based on at least one of the video of the screen associated with the base DUT during the execution of the test-suite on the base DUT and the plurality of input events associated with the execution of the test-suite on the base DUT;
generating a test script corresponding to the configuration data; and
executing the test script on at least one secondary DUT.

14. The non-transitory computer-readable medium of claim 13, wherein capturing the execution of the test-suite on the base DUT further comprises:
identifying one or more objects within the video of the screen associated with the base DUT during the execution of the test-suite on the base DUT, wherein the one or more objects are identified based on at least one of: image processing, optical character recognition (OCR), and machine learning (ML), and
recording a sequence of the plurality of input events associated with the execution of the test-suite on the base DUT.

15. The non-transitory computer-readable medium of claim 14, wherein the plurality of input events associated with the execution of the test-suite on the base DUT comprises:
at least one keyboard input; and
at least one mouse input.

16. The non-transitory computer-readable medium of claim 15,
wherein executing the test script on the at least one secondary DUT comprises at least one of:
executing a keyboard action on the at least one secondary DUT corresponding to the keyboard input associated with the base DUT, in association with the one or more objects; and
executing a mouse action on the at least one secondary DUT corresponding to the mouse input associated with the base DUT, in association with the one or more objects,
wherein the keyboard action is executed via one of:
a keyboard simulator; and
a robotic arm configured to press one or more keys of the keyboard associated with the at least one secondary DUT, and
wherein the mouse action is executed via one of:
a mouse simulator; and
a robotic arm configured to perform a mouse action associated with the at least one secondary DUT.
